(19) United States
(12) Patent Application Publication
(10) Pub. No.: US 2025/0367543 A1
(43) Pub. Date: Dec. 4, 2025

(54) GAME CONTROLLER

(71) Applicant: DEXIN CORP., New Taipei City (TW)

(72) Inventors: Ho Lung LU, New Taipei City (TW); Chin-Lung LIN, New Taipei City (TW); Yi-Chen LIU, New Taipei City (TW)

(73) Assignee: DEXIN CORP., New Taipei City (TW)

(21) Appl. No.: 19/215,765

(22) Filed: May 22, 2025

Related U.S. Application Data
(60) Provisional application No. 63/652,534, filed on May 28, 2024.

(30) Foreign Application Priority Data
May 7, 2025 (TW) 114117165

(51) Int. Cl. A63F 13/24

(52) U.S. Cl. CPC A63F 13/24

(57) ABSTRACT

A game controller includes a first control handle, a second control handle, a first stretchable assembly and a second stretchable assembly. The first and second stretchable assemblies are slidably disposed on the first and second control handles, respectively, and the first and second stretchable assemblies are pivotally connected to each other, allowing the first and second control handles to slide relative to each other into a combined mode or a separated mode, and allowing the first stretchable assembly to pivot relative to the second stretchable assembly. When the game controller is in the combined mode, the first and second control handles are joined together for use with the game console. When the game controller is in the separated mode, the first and second control handles are separated, thereby forming a mounting space between the first and second control handles for assembling the mobile device.

### CROSS-REFERENCE TO RELATED APPLICATIONS

This non-provisional application claims priority under 35 U.S.C. § 119(a) on provisional patent application No. 63/652,534 filed in U.S.A. on May 28, 2024, and on patent application No(s). 114117165 filed in Taiwan, R.O.C. on May 7, 2025, the entire contents of which are hereby incorporated by reference.

### TECHNICAL FIELD

The present disclosure relates to a game controller, and more particularly to a game controller that can be used with either a mobile device or a video game console.

### BACKGROUND

With the increasing popularity of smartphones equipped with touch screens (e.g., iPhones and Android phones), the mobile gaming market has rapidly expanded, and the revenue from mobile games has even surpassed the combined revenue of console and PC games.

Generally, if a player wants to play mobile games, a game controller compatible with mobile devices must be purchased. Conversely, if the player wants to play on a video game console, a different controller compatible with the console must be purchased. This not only increases the cost of acquiring gaming equipment but also requires more storage space for the devices. Furthermore, if a player fails to properly store the controllers and misplaces one of them, they may be unable to play mobile games or console games.

### SUMMARY

The present disclosure provides a game controller that can be used with either mobile games or video game consoles.

One embodiment of the present disclosure provides a game controller adapted to be cooperated with a game console or a mobile device. The game controller includes a first control handle, a second control handle, a first stretchable assembly, and a second stretchable assembly. The first stretchable assembly is slidably disposed on the first control handle, the second stretchable assembly is slidably disposed on the second control handle, and the first stretchable assembly and the second stretchable assembly are pivotally connected to each other, allowing the first control handle and the second control handle to slide relative to each other into either a combined mode or a separated mode via the first stretchable assembly and the second stretchable assembly, and further allowing the first stretchable assembly and the first control handle to pivot relative to the second stretchable assembly and the second control handle. In addition, when the game controller is in the combined mode, the first control handle and the second control handle are joined together for use with the game console; when the game controller is in the separated mode, the first control handle and the second control handle are separated, thereby forming a mounting space between the first control handle and the second control handle for assembling the mobile device.

According to the game controller as discussed in the above embodiment, by pivotally connecting the first stretchable assembly and the second stretchable assembly, when the user intends to use the game controller with a mobile device, the first control handle and the second control handle can be separated into a separated mode, and the first stretchable assembly can be pivoted relative to the second stretchable assembly to provide a larger mounting space for assembling the mobile device, thereby reducing the likelihood of mechanical interference between the mobile device and the control handles when the mobile device is placed into the mounting space.

### BRIEF DESCRIPTION OF THE DRAWINGS

The present disclosure will become better understood from the detailed description given herein below and the accompanying drawings which are given by way of illustration only and thus are not intending to limit the present disclosure and wherein:

FIG. 1 is a perspective view of a game controller in a combined mode according to one embodiment of the present disclosure;

FIG. 2 is a top view of the game controller in FIG. 1 in a separated mode;

FIG. 3 is a perspective view of the game controller in FIG. 2 with a first stretchable assembly in a clearance position;

FIG. 4 and FIG. 5 are schematic views illustrating an operation of assembling a mobile device in a mounting space between a first control handle and a second control handle;

FIG. 6 is a partial sectional view of the game controller in FIG. 2;

FIG. 7 is a partial cross-sectional view of the game controller in FIG. 2; and

FIG. 8 is a partial cross-sectional view of the game controller in FIG. 3.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In addition, the terms used in the present disclosure, such as technical and scientific terms, have its own meanings and can be comprehended by those skilled in the art, unless the terms are additionally defined in the present disclosure. That is, the terms used in the following paragraphs should be read on the meaning commonly used in the related fields and will not be overly explained, unless the terms have a specific meaning in the present disclosure.

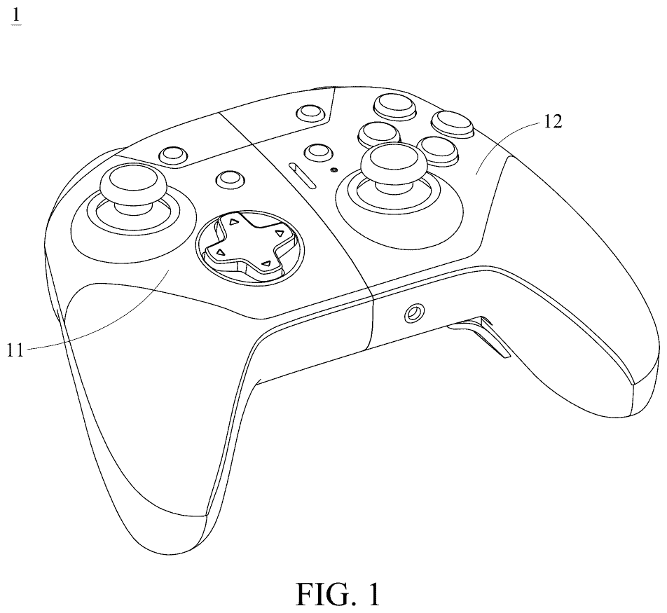

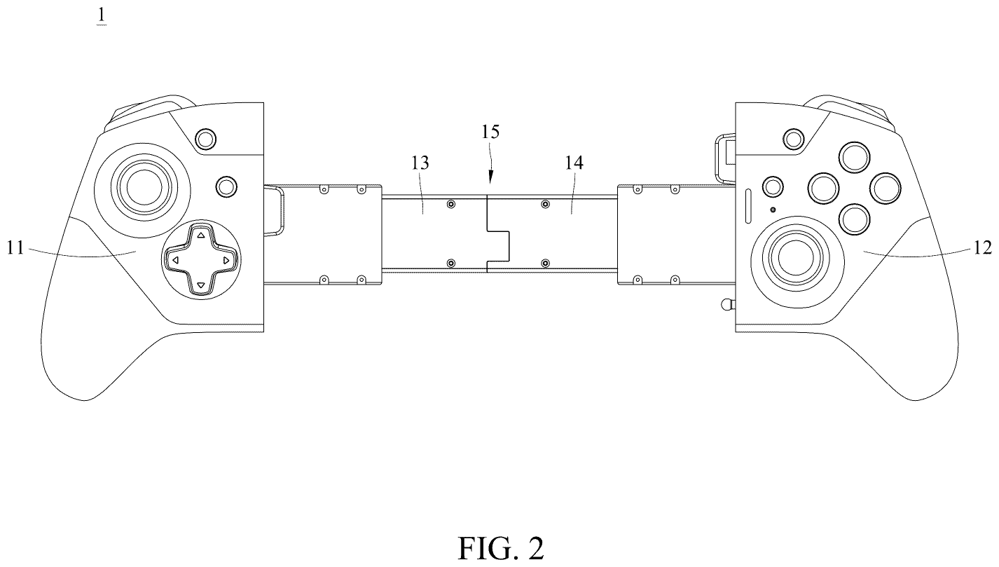

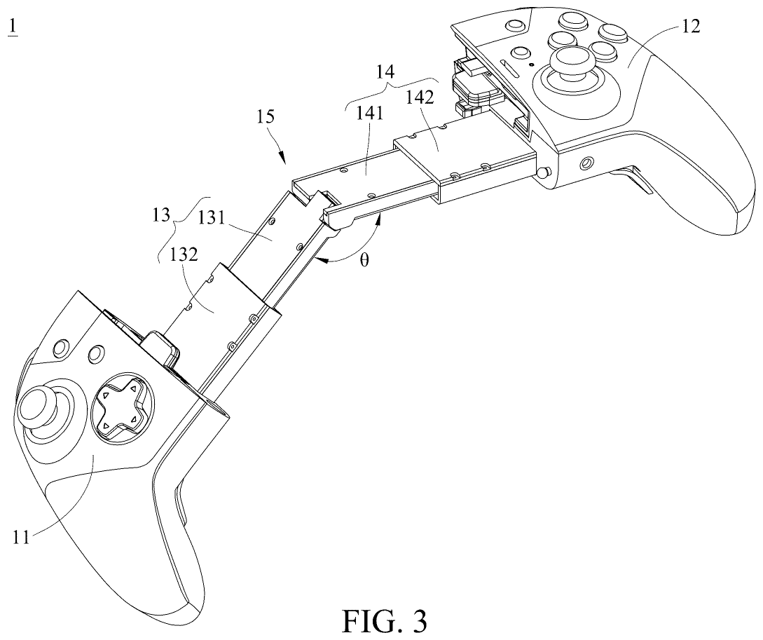

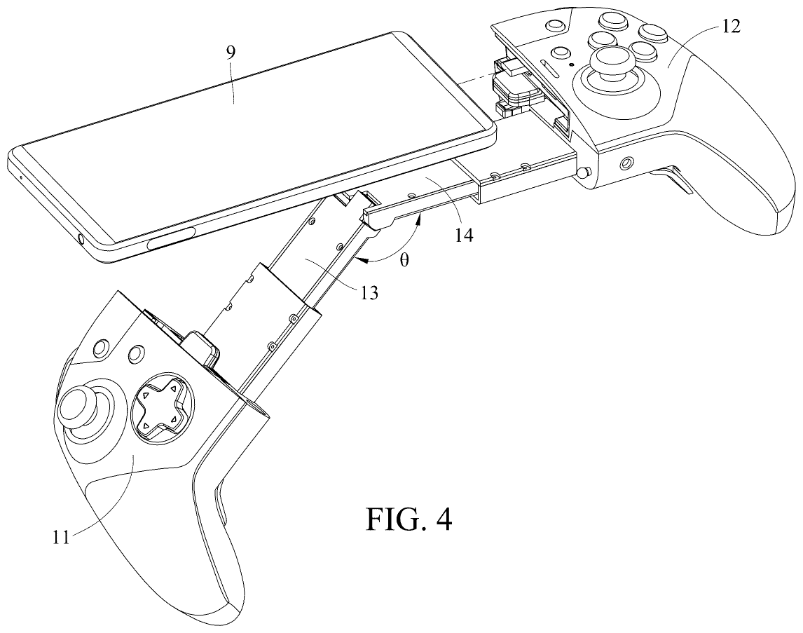

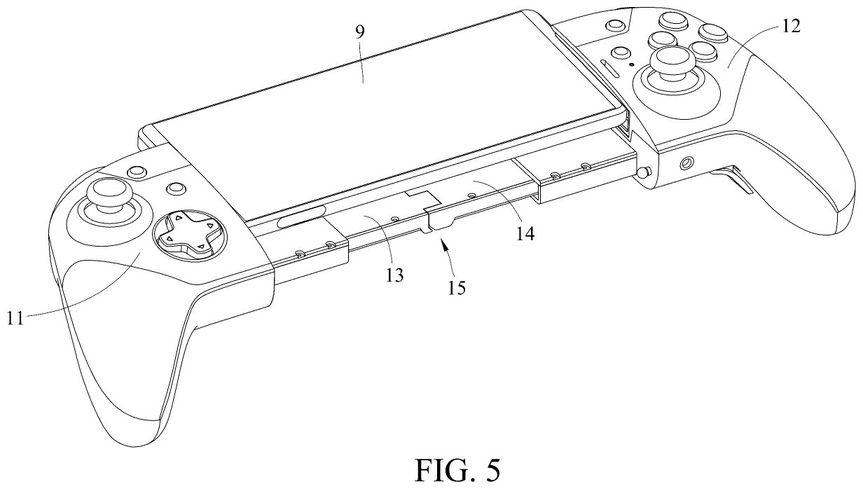

Please refer to FIG. 1 to FIG. 5. FIG. 1 is a perspective view of a game controller in a combined mode according to one embodiment of the present disclosure, FIG. 2 is a top view of the game controller in FIG. 1 in a separated mode, FIG. 3 is a perspective view of the game controller in FIG. 2 with a first stretchable assembly in a clearance position, and FIG. 4 and FIG. 5 are schematic views illustrating an operation of assembling a mobile device in a mounting space between a first control handle and a second control handle.

In this embodiment, a game controller 1 is provided. The game controller 1 is suitable for use with a game console (not shown in figures) or a mobile device 9. The game console may be, for example, a television game console such as an Xbox or PS5. The mobile device 9 may be, for example, a smartphone or a tablet, and its operating system may be iOS or Android.

The game controller 1 includes a first control handle 11, a second control handle 12, a first stretchable assembly 13, and a second stretchable assembly 14.

The first stretchable assembly 13 is slidably disposed on the first control handle 11, the second stretchable assembly 14 is slidably disposed on the second control handle 12, and the first stretchable assembly 13 and the second stretchable assembly 14 are pivotally connected to each other, allowing the first control handle 11 and the second control handle 12 to slide relative to each other into either a combined mode (as shown in FIG. 1) or a separated mode (as shown in FIG. 2) via the first stretchable assembly 13 and the second stretchable assembly 14, and further allowing the first stretchable assembly 13 and the first control handle 11 to pivot relative to the second stretchable assembly 14 and the second control handle 12.

As shown in FIG. 1, when the game controller 1 is in the combined mode, the first control handle 11 and the second control handle 12 are joined together for use with the game console. As shown in FIG. 2, when the game controller 1 is in the separated mode, the first control handle 11 and the second control handle 12 are separated, thereby forming a mounting space between the first control handle 11 and the second control handle 12 for assembling the mobile device 9.

The first stretchable assembly 13 is pivotable relative to the second stretchable assembly 14 between a horizontal position (as shown in FIG. 2) and a clearance position (as shown in FIG. 3). As shown in FIG. 2, when the first stretchable assembly 13 is in the horizontal position, the first stretchable assembly 13 and the second stretchable assembly 14 are disposed parallel to each other. As shown in FIG. 3, when the first stretchable assembly 13 is in the clearance position, an angle θ is formed between the first stretchable assembly 13 and the second stretchable assembly 14.

As shown in FIG. 3 to FIG. 5, when the user intends to use the game controller 1 with the mobile device 9, the first stretchable assembly 13 and the second stretchable assembly 14 can first be slid relative to each other to be in the separated mode, and then the first stretchable assembly 13 can be pivoted relative to the second stretchable assembly 14 to be in the clearance position, allowing the mobile device 9 to be assembled. As shown in FIG. 4, when the mobile device 9 is to be placed into the mounting space between the first control handle 11 and the second control handle 12, the first stretchable assembly 13 is pivoted relative to the second stretchable assembly 14 into the clearance position in advance, thereby reducing the likelihood of interference between the mobile device 9 and the handles during placement and facilitating the assembly of the mobile device 9. After the mobile device 9 is placed into the mounting space, the first stretchable assembly 13 is then pivoted relative to the second stretchable assembly 14 back to the horizontal position (as shown in FIG. 5) to complete the assembly of the mobile device 9.

In this embodiment, when the first stretchable assembly 13 is in the clearance position, the angle θ formed between the first stretchable assembly 13 and the second stretchable assembly 14 is 135 degrees; that is, the first stretchable assembly 13 is pivoted 45 degrees from the horizontal position to the clearance position, but the present disclosure is not limited thereto. In other embodiments, when first stretchable assembly is in the clearance position, the angle between the first stretchable assembly and the second stretchable assembly may be any value within the range of 120 degrees to 150 degrees.

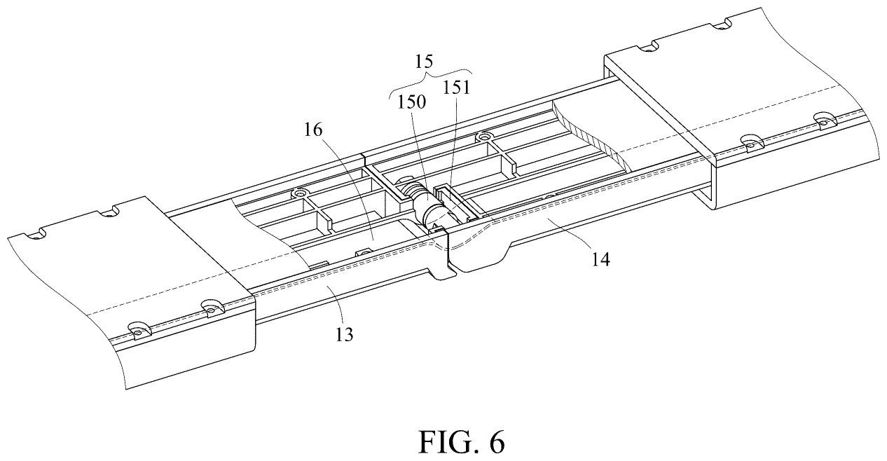

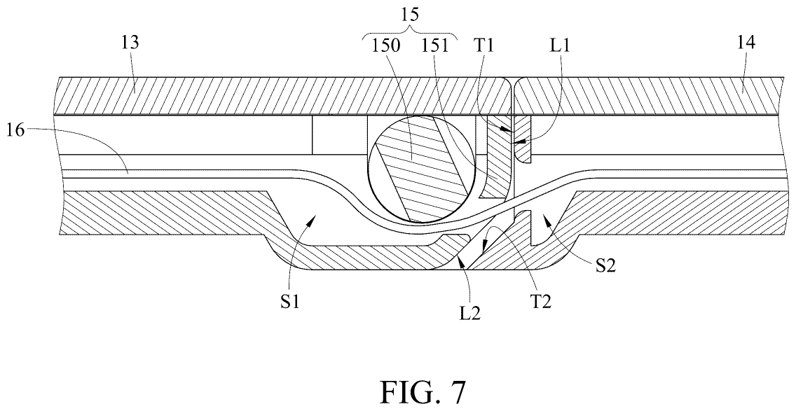

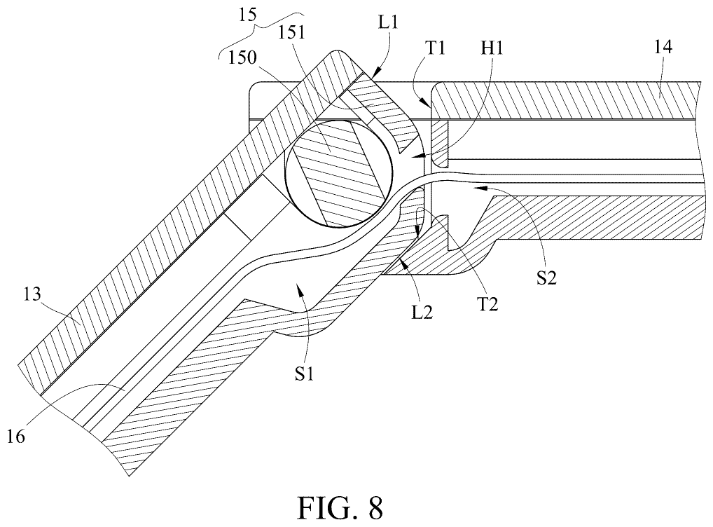

Furthermore, please refer to FIG. 6 to FIG. 8. FIG. 6 is a partial sectional view of the game controller in FIG. 2, FIG. 7 is a partial cross-sectional view of the game controller in FIG. 2, and FIG. 8 is a partial cross-sectional view of the game controller in FIG. 3. The game controller 1 includes a pivot mechanism 15, and the pivot mechanism 15 includes a shaft 150 and a sleeve structure 151. As shown in FIG. 6, the shaft 150 is fixed to the second stretchable assembly 14, the sleeve structure 151 is disposed on the first stretchable assembly 13, and the sleeve structure 151 is sleeved around the shaft 150 and is rotatable about an axis of the shaft 150. In this embodiment, a minimum diameter of the pivot mechanism 15 is, for example, 4.5 mm, but the present disclosure is not limited thereto.

As shown in FIG. 7 and FIG. 8, the second stretchable assembly 14 has a first stopping surface T1 and a second stopping surface T2, and the first stretchable assembly 13 has a first abutting surface L1 and a second abutting surface L2. Additionally, when the first stretchable assembly 13 is in the horizontal position, the first abutting surface L1 abuts against the first stopping surface T1. When the first stretchable assembly 13 pivots to the clearance position in a direction away from the mounting space, the second abutting surface L2 abuts against the second stopping surface T2.

As shown in FIG. 2, the first stretchable assembly 13 includes a first rail 131 and a second rail 132, and the first rail 131 is slidably disposed on the first control handle 11, and the second rail 132 is slidably disposed on the first rail 131. The second stretchable assembly 14 includes a third rail 141 and a fourth rail 142, and the third rail 141 is slidably disposed on the second control handle 12, and the fourth rail 142 is slidably disposed on third rail 141. Moreover, the second rail 132 and the fourth rail 142 are pivotally connected to each other. In this embodiment, a width of the first rail 131 is greater than a width of the second rail 132, and a width of the third rail 141 is greater than a width of the fourth rail 142.

The first stretchable assembly 13 may further have a first latching structure (not shown in figures), and the second stretchable assembly 14 may further have a second latching structure (not shown in figures). In addition, when the first stretchable assembly 13 is in the horizontal position, the first latching structure detachably engages with the second latching structure, thereby securing the first stretchable assembly 13 in the horizontal position to stably support the mobile device 9. The first latching structure and the second latching structure may be, for example, a protrusion and a recess configured to engage with each other, but the present disclosure is not limited thereto.

As shown in FIG. 6, the game controller 1 further includes a cable 16. The first stretchable assembly 13 has a first wiring space S1, and the second stretchable assembly 14 has a second wiring space S2. The sleeve structure 151 has a wiring hole H1 connected to the first wiring space S1 and the second wiring space S2. The cable 16 is disposed in the first wiring space S1 and the second wiring space S2 and passes through the wiring hole H1, and the cable 16 connects the first control handle 11 and the second control handle 12. Moreover, the cable 16 is, for example, disposed adjacent to the shaft 150. Since the angle θ between the first stretchable assembly 13 and the second stretchable assembly 14 is limited within a specific range (e.g., between 120 degrees and 150 degrees) when the first stretchable assembly 13 is in the clearance position, the wiring hole H1 remains in communication with both the first wiring space S1 and the second wiring space S2 as the first stretchable assembly 13 pivots relative to the second stretchable assembly 14 between the horizontal position and the clearance position, thereby preventing the cable 16 from encountering mechanical interference.

According to the game controller as discussed in the above embodiment, by pivotally connecting the first stretchable assembly and the second stretchable assembly, when the user intends to use the game controller with a mobile device, the first control handle and the second control handle can be separated into a separated mode, and the first stretchable assembly can be pivoted relative to the second stretchable assembly to provide a larger mounting space for assembling the mobile device, thereby reducing the likelihood of mechanical interference between the mobile device and the control handles when the mobile device is placed into the mounting space.

It will be apparent to those skilled in the art that various modifications and variations can be made to the present disclosure. It is intended that the specification and examples be considered as exemplary embodiments only, with a scope of the present disclosure being indicated by the following claims and their equivalents.

What is claimed is:

1. A game controller, adapted to be cooperated with a game console or a mobile device, and the game controller comprising:
a first control handle and a second control handle; and
a first stretchable assembly and a second stretchable assembly, wherein the first stretchable assembly is slidably disposed on the first control handle, the second stretchable assembly is slidably disposed on the second control handle, and the first stretchable assembly and the second stretchable assembly are pivotally connected to each other, allowing the first control handle and the second control handle to slide relative to each other into either a combined mode or a separated mode via the first stretchable assembly and the second stretchable assembly, and further allowing the first stretchable assembly and the first control handle to pivot relative to the second stretchable assembly and the second control handle;
wherein when the game controller is in the combined mode, the first control handle and the second control handle are joined together for use with the game console; when the game controller is in the separated mode, the first control handle and the second control handle are separated, thereby forming a mounting space between the first control handle and the second control handle for assembling the mobile device.

2. The game controller according to claim 1, wherein the first stretchable assembly is pivotable relative to the second stretchable assembly between a horizontal position and a clearance position; and
wherein when the first stretchable assembly is in the horizontal position, the first stretchable assembly and the second stretchable assembly are disposed parallel to each other; when the first stretchable assembly is in the clearance position, an angle is formed between the first stretchable assembly and the second stretchable assembly.

3. The game controller according to claim 2, wherein the second stretchable assembly has a first stopping surface and a second stopping surface, and the first stretchable assembly has a first abutting surface and a second abutting surface; and
wherein when the first stretchable assembly is in the horizontal position, the first abutting surface abuts against the first stopping surface; when the first stretchable assembly pivots to the clearance position in a direction away from the mounting space, the second abutting surface abuts against the second stopping surface.

4. The game controller according to claim 2, wherein when the first stretchable assembly is in the clearance position, the angle formed between the first stretchable assembly and the second stretchable assembly is greater than or equal to 120 degrees and less than or equal to 150 degrees.

5. The game controller according to claim 4, wherein when the first stretchable assembly is in the clearance position, the angle formed between the first stretchable assembly and the second stretchable assembly is 135 degrees.

6. The game controller according to claim 2, wherein the first stretchable assembly has a first latching structure, and the second stretchable assembly has a second latching structure; and
wherein when the first stretchable assembly is in the horizontal position, the first latching structure detachably engages with the second latching structure, thereby securing the first stretchable assembly in the horizontal position.

7. The game controller according to claim 1, wherein the first stretchable assembly comprises a first rail and a second rail, the second stretchable assembly comprises a third rail and a fourth rail, the first rail is slidably disposed on the first control handle, the second rail is slidably disposed on the first rail, the third rail is slidably disposed on the second control handle, the fourth rail is slidably disposed on the third rail, and the second rail and the fourth rail are pivotally connected to each other.

8. The game controller according to claim 7, wherein a width of the first rail is greater than a width of the second rail, and a width of the third rail is greater than a width of the fourth rail.

9. The game controller according to claim 1, further comprising a pivot mechanism, wherein the pivot mechanism comprises a shaft and a sleeve structure, the shaft is fixed to the second stretchable assembly, the sleeve structure is disposed on the first stretchable assembly, and the sleeve structure is sleeved around the shaft and is rotatable about an axis of the shaft.

10. The game controller according to claim 9, further comprising a cable, wherein the first stretchable assembly has a first wiring space, the second stretchable assembly has a second wiring space, the sleeve structure has a wiring hole connected to the first wiring space and the second wiring space, the cable is disposed in the first wiring space and the second wiring space and passes through the wiring hole, and the cable connects the first control handle and the second control handle.
